(19) United States
(12) Patent Application Publication
(10) Pub. No.: US 2015/0252274 A1
(43) Pub. Date: Sep. 10, 2015

(54) ENTRAINED FLOW GASIFIER HAVING AN INTEGRATED INTERMEDIATE TEMPERATURE PLASMA

(71) Applicant: SIEMENS AKTIENGESELLSCHAFT, München (DE)

(72) Inventors: Thomas HAMMER, Hemhofen (DE); Frank HANNEMANN, Freiberg (DE); Doris KLOSTERMANN, Freiberg (DE); Alexander TREMEL, Erlangen (DE)

(21) Appl. No.: 14/639,505

(22) Filed: Mar. 5, 2015

(30) Foreign Application Priority Data
Mar. 5, 2014 (DE) 102014204027.2

(51) Int. Cl. C10J 3/46; C01B 3/32; C10J 3/80; C10J 3/48; C10J 3/86

(52) U.S. Cl. CPC C10J 3/466; C10J 3/485; C10J 3/86; C10J 3/80; C01B 3/32; C10J 2200/09; C10J 2300/0916; C10J 2300/0976; C10J 2300/0959; C10J 2300/1238; C10J 2300/1687; C10J 2300/1603; C10J 2300/1884; C10J 2300/1869; C10J 2300/1892; C01B 2203/02; C01B 2203/0861; C01B 2203/0877; C01B 2203/042; C01B 2203/0415

(57) ABSTRACT

A process for gasifying solid or liquid gasification materials, in particular biomass, at pressures in the range from atmospheric pressure to 10 MPa and at gasification temperatures in the range from 800° C. to 1500° C. to form a highly calorific synthesis gas. An endothermic steam gasification process proceeds in a gasification space of an entrained flow gasifier, and a plasma of intermediate temperature (typically <3500° C., preferably <2000° C.) introduces heat of reaction into the gasification space in such a quantity that the gasification temperature is kept below the ash softening temperature of 1500° C. Endothermic reactions, in particular reactions having a high activation energy, proceed at high rates at far lower gas temperatures than in the case of a thermal process. The gasification process, which does not require an oxygen plant, gives a crude gas which is free of hydrocarbons.

### CROSS-REFERENCE TO RELATED APPLICATIONS

The present application which claims priority of German Patent Application No. 102014204027.2, filed Mar. 5, 2014, the contents of which are incorporated by reference herein.

### TECHNICAL FIELD

The invention relates to a process and an apparatus for gasifying solid or liquid gasification materials at pressures in the range from atmospheric pressure to 10 MPa and at temperatures in the range from 800° C. to 1500° C. to form synthesis gas.

### TECHNICAL BACKGROUND

The invention further relates to a process and an entrained flow gasifier for gasifying liquid or solid fuels, in particular biomass, by means of steam as oxidant and using a plasma generator at gasification temperatures in the range from 800 to 1500° C. and pressures in the range from ambient pressure to 10 MPa (100 bar) to form a highly calorific synthesis gas.

Due to the globally increasing proportion of renewable energies having a fluctuating character, e.g. photovoltaic or wind energy, there are new requirements for national energy supply systems. The installed power output of these fluctuating energy sources can only be used purposefully when energy from these sustainable sources can be stored efficiently during times of low demand and can be fed into the energy supply grid either when the demand for energy exceeds the energy supply or when the stored energy helps reduce the demand for fossil primary energy carriers in another way. Previous approaches have been generation of hydrogen from renewable energy by means of electrolysis, which represents an ideal highly dynamic load for such applications. The hydrogen can be utilized by synthesis of hydrocarbons such as methane by reacting the electrolytically generated hydrogen (H₂) with a carbon carrier such as carbon dioxide (CO₂). However, inexpensive CO₂, e.g. from geological sources or from biogas plants, is available only in small quantities and normally not readily available where the electrolysis would be placed as energy sink, i.e., for example, in the vicinity of offshore wind farms. On the other hand, CO₂ obtained by separation from power station offgases or even from the ambient air is so expensive that a synthesis of hydrocarbons is not an economical option even from a long-term point of view.

Here, on the other hand, it is assumed biomass can be utilized not only as a source of renewable energy generation as previously but also for producing a highly calorific, storable product for the storage of renewable excess power from wind and solar power stations. This product can be hydrogen, synthetic natural gas, diesel fuel from a Fischer Tropsch synthesis or methanol and products produced in further synthesis steps, for example dimethyl ether (DME) or olefins. In contrast to highly calorific substances such as methanol or hydrogen, biomass represents a low-energy fuel which without further treatment can be used only for heating purposes or for power generation with very low efficiencies. In order to be able to obtain higher efficiencies in the utilization of biomass, air-blown fixed-bed or fluidized-bed gasifiers which convert the biomass into a synthesis gas and then feed it to a gas engine or a gas turbine for power generation are used. Such processes can achieve efficiencies of above 30% but require complicated gas purification to remove tar compounds and undesirable hydrocarbons. Owing to the high proportion of nitrogen, the synthesis gas produced has a low calorific value and is unsuitable for synthesis processes and chemical energy storage. This disadvantage can be overcome by the use of autothermal oxygen-operated entrained flow gasification processes, enabling a synthesis product suitable for chemical storage to be produced. Entrained flow gasification processes are in turn only economical for high throughputs, require an oxygen plant and complicated biomass drying and treatment, as a result of which they are unsuitable for decentralized biomass utilization.

There have already been proposals to introduce the required heat of reaction via a plasma. For this purpose, the “Alter NRG Plasma Gasification System” has been proposed, for example by van Nierop, “Alter NRG Plasma gasification system for waste and biomass gasification” at the Gasification Technologies Council 2009. Further developments have been presented by A. Gorodetsky “Westinghouse plasma gasification technology and project update” at the 11th European gasification conference on May 8-12, 2012 in Session 4 in Cagliari, Italy. This technology utilizes the known atmospheric-pressure fixed-bed gasification and introduces part of the required heat of reaction via a plurality of electrically excited plasma generators. As gasification agents, steam and optionally oxygen or air are fed in. A particular disadvantage has been found to be the arrangement of the reaction zones of drying zone, pyrolysis zone, reduction and oxidation zone, which is typical of fixed-bed gasification and in which flow occurs from the bottom upward. Particularly in the pyrolysis zone, hydrocarbons which can amount to up to 10% of the amount of fuel introduced are released. The tars and oils, in particular, present therein have to be separated off from the crude gas, which requires a particularly large outlay for treatment. The aqueous condensates obtained during cooling of the gas contain many organic acids, phenols and organic sulfur compounds which require comprehensive wastewater treatment and greatly pollute the environment.

### SUMMARY OF THE INVENTION

It is an object of the invention to provide a gasification process which produces a high-quality synthesis gas and is suitable for production of hydrogen and also for downstream synthesis processes, requires no oxygen plant and no complicated biomass pretreatment and additionally gives a crude gas which is free of hydrocarbons.

The invention provides a combination of an entrained flow gasifier with a plasma generator for a nonthermal plasma of intermediate temperature (typically <3500° C., preferably <2000° C.) and links the provision of chemically active radicals and thermal energy by the plasma with steam gasification of the fuel used. For the present purposes, a nonthermal plasma of intermediate temperature is a plasma which, in contrast to a thermal electric arc, cannot be described by thermodynamic equilibrium relationships but heats the gas treated in the plasma to temperatures of some 1000° C. Here, the temperature which can be imparted to the uncharged gas is far below the temperatures which, for example, would be necessary for describing the degree of ionization or the average electron energy in the plasma. This gives the advantage that endothermic reactions, in particular those having a high activation energy, can proceed at high rates at far lower gas temperatures than in the case of a thermal process.

A nonthermal intermediate temperature plasma can be generated particularly simply by means of a DC or AC gas discharge between metallic electrodes, where, in the case of an AC discharge, the frequency of the applied voltage can be varied within wide limits. Here, it will be ensured by means of suitable control measures for the electric energy supply and the gas flow through the plasma that the energy is dissipated not only in the vicinity of the electrodes but is introduced as efficiently as possible into the volume of the gasification reactor.

Other possible ways of producing an intermediate temperature plasma without use of metallic electrodes which are in contact with the plasma gas are injection of electric energy into a flowing gas by means of electromagnetic waves. In the radio-frequency range from a few MHz up to some 100 MHz, there is the possibility of capacitive injection by means of external electrodes or the possibility of inductive energy coupling by means of coils around an electrically insulating plasma gas feed conduit, and in the range of microwaves possibilities are injection by means of structured waveguides, antennae and the like, which can likewise be effected through or even with the aid of the dielectric properties of insulating, gas-conducting structures.

In the case of a plasma gasifier, preference is given to using one or more lances for producing large plasma volumes. Each lance comprises means for introduction of energy using DC and low-frequency AC (electrodes) or electromagnetic waves (waveguides, coils, etc.) and for introduction of gas.

The water required for the gasification process can be introduced together with the fuel or via a separate steam inlet. The gasification reaction is entirely endothermic, with the energy required for cracking being introduced via the plasma. The temperature of the gasification process is, at a predetermined inflow of biomass having a particular composition (C/H/O ratio and enthalpy as materials parameters), regulated firstly by means of the plasma power and secondly by means of the gas flow introduced from the outside via the plasma, which simultaneously serves as gasification medium, to a temperature level below 1500° C. in order to prevent melting of the ash constituents of the fuel. Either the steam required for the reaction, additional oxygen or air or recirculated synthesis gas is used for this purpose.

To increase the operating life of the electrodes in the case of a plasma excited directly by electrodes, the plasma gas is preferably introduced in such a way that it cools the electrodes. This can be achieved by the plasma gas being fed in as gas sheathing the electrodes or else through the electrodes themselves.

In the case of indirectly, i.e. capacitively, inductively or generally by means of electromagnetic waves, coupled high-frequency plasmas, the plasma gas is introduced in such a way that cooling of the insulating structures through which the energy is injected into the plasma gas is ensured.

When additional oxygen or air is used, the power of the plasma generator can be reduced and part of the reaction energy can be provided by an exothermic reaction of the oxygen. The associated shifting of the reaction energy from the plasma to exothermic oxidation reactions enables the electric power uptake of the system to be reduced, with a change of the gas quality in the direction of lower hydrogen contents occurring.

The required particle size of the solid fuel is <2 mm, with a mechanical feed system, for example a feed screw, being provided for introduction into the reaction space. As an alternative, liquid introduction using atomizer nozzles is possible. The reaction rate of the gasification reaction is accelerated by the reaction in the plasma environment (for example reaction with free radicals, high heat flow density), as a result of which, when using an entrained flow gasifier, a high carbon conversion can be achieved at gasification temperatures below the slag softening point. To increase the degree of carbon conversion, recirculation of the solids removed after the gasification process, which consist of ash and unreacted carbon, is possible.

The synthesis gas produced contains a high proportion of hydrogen because of the allothermal gasification process and is cooled downstream of the plasma gasifier by water quenching or by means of a waste heat boiler.

The utilization of the sensible heat for steam generation in a waste heat boiler is possible, for example for generating the steam for the gasification reaction and for cooling the lances of the plasma generator, or can be integrated into a use with power-heat coupling, which offers the possibility of an increase in the efficiency. As an alternative, a combination of water quenching to <600° C. (partial quenching) and subsequent waste heat utilization is possible. This arrangement offers the advantage of condensation of the alkaline constituents present especially in biomass before entry into the waste heat boiler and allows utilization of inexpensive materials.

After cooling of the synthesis gas to temperatures of <600° C., the ash constituents can also be separated off before entry into the waste heat boiler. This purification of the synthesis gas is carried out, in the case of utilization of the waste heat, by means of cyclone precipitation, electrofilters or mechanical filter units such as ceramic filter candles or cloth filters. In the case of full quenching of the synthesis gas by injection of water, a wet scrub, for example via a Venturi scrubber, is used.

After the mechanical purification and cooling of the synthesis gas, a substream can be recirculated and used for cooling the plasma lance.

The purified synthesis gas is subsequently passed to further processes for hydrogen production, chemical syntheses or power generation by means of gas engines, fuel cells or gas turbines.

The invention is illustrated below as a working example within a scope required for understanding and with the aid of figures. The figures show:

### BRIEF DESCRIPTION OF THE DRAWINGS

FIG. 1 a first variant of a gasification reactor according to the invention having a plasma generator with synthesis gas recirculation for cooling the plasma lances and also water quenching and wet purification,

FIG. 2 a second variant of a gasification reactor according to the invention having a plasma generator with cooling of the plasma lances by means of steam and recirculated synthesis gas and also partial water quenching, waste heat utilization and dry precipitation of the ash particles,

FIG. 3 a third variant of a gasification reactor according to the invention having a plasma generator with steam cooling of the plasma lances and also additional introduction of preheated air into the reactor, waste heat utilization and dry precipitation of the ash particles.

### DESCRIPTION OF EMBODIMENTS

In the figures, identical designations denote identical elements.

Three possible process engineering implementations of the invention are described.

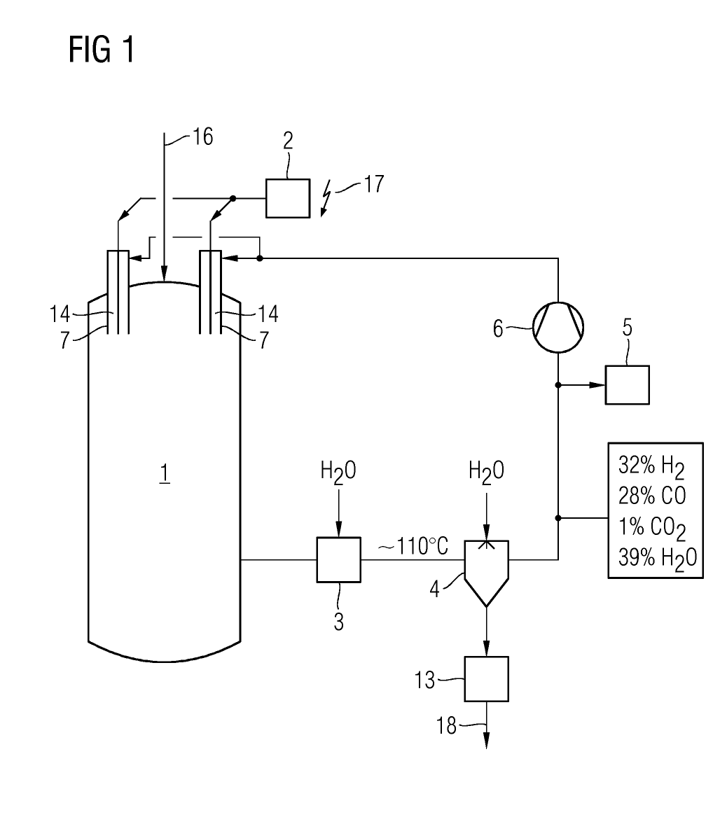

Variants as Per FIG. 1

The process concept of the invention is illustrated in principle with the aid of FIG. 1.

The arrangement according to the invention has two main components:
the gasification reactor (1)
the plasma generator (2)

The reaction of the biomass occurs in the gasification reactor (1) with the aid of the plasma generator (2) and introduction of recirculated moist synthesis gas at temperatures in the range from 800° C. to 1500° C. below the ash melting point, with the introduction of the biomass (for example sawdust) having an average particle size of <2 mm being effected by means of a feed screw. The endothermic steam reaction of the fuel forms a highly calorific synthesis gas. The hot crude gas flows from the gasification reactor (1) into a quenching space (3) and is there cooled to temperatures of about 110° C. by evaporation of the water and saturation of the crude gas. The cooled crude gas is subsequently fed to a wet scrub (4) for separating off particles and mechanically purified by means of a Venturi scrubber. The synthesis gas which has been freed of ash particles contains about 32% by volume of H₂ and 28% by volume of CO and is subsequently fed to a chemical synthesis or hydrogen plant (5), with part of the saturated synthesis gas being recirculated by means of a blower (6) for cooling the plasma lances (7) and for providing steam to the gasification reaction. The particle-laden wastewater from the wet scrub is subsequently purified in a sooty water plant (13) and the filter cake (18) is discharged. The purified wastewater is recirculated to the process.

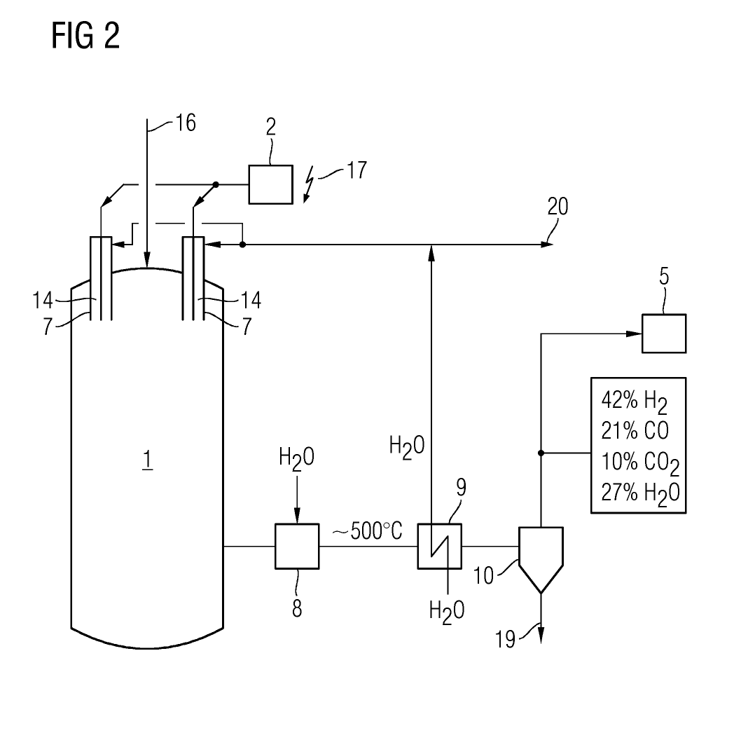

Variant as Per FIG. 2

The embodiment of FIG. 2 differs from the embodiment of FIG. 1 by a lowering of the crude gas temperature to about 500° C. by means of partial quenching (8) and subsequent generation of steam in a waste heat boiler (9). The steam generated in the waste heat boiler is utilized for cooling the plasma lances (7) and as gasifier steam. Excess steam (20) is used for heating purposes or for power-heat coupling. The crude gas is cooled to about 170° C. in the waste heat boiler (9) and then purified in a dry dust filter (10), with ash particles and unreacted fuel being separated out. The dust filter (10) can also be used upstream of the waste heat boiler. The purified synthesis gas is subsequently fed to a chemical synthesis or hydrogen plant (5).

The embodiment as per FIG. 2 leads to an increase in the hydrogen content in the synthesis gas and in the efficiency since part of the steam can be used for applications of power-heat coupling or heating purposes and no additional blower is required.

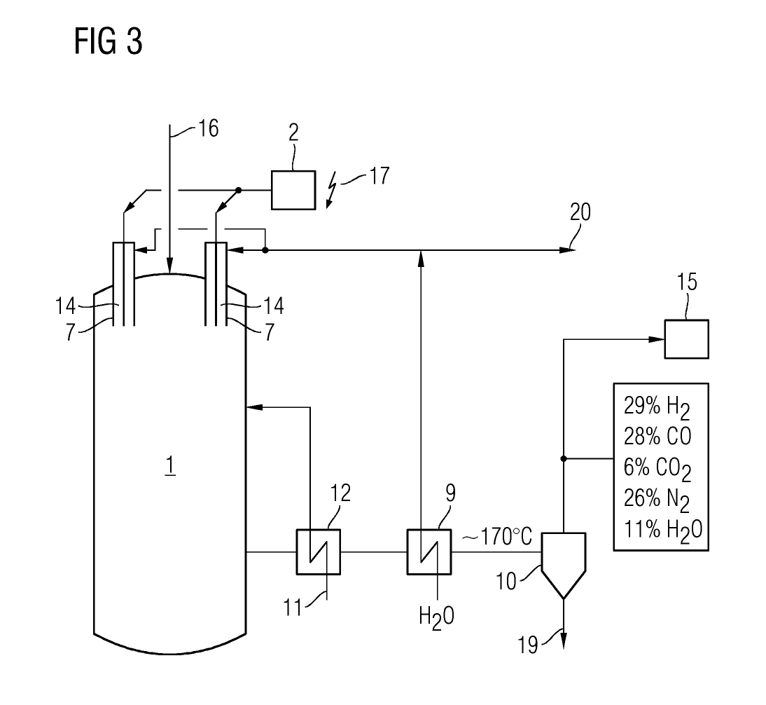

Variant as Per FIG. 3

The embodiment of FIG. 3 differs from FIGS. 1 and 2 by additional introduction of oxygen-containing gas, in this example air (11), into the gasification reactor. The crude gas produced is subsequently cooled to about 170° C. in a two-stage waste heat boiler. Within the first stage (12), the air introduced into the gasification reactor is preheated and in the second stage (9) steam is generated for cooling of the plasma lances and the steam reaction. Excess steam (20) is utilized in a plant for power-heat coupling (process steam). The crude gas leaving the waste heat boiler is then freed of ash particles in a next process step (10). This purification step is carried out by means of dry filter systems such as cloth filters or an electrofilter. After the mechanical purification, the synthesis gas is utilized for power generation in a gas engine, a fuel cell or gas turbine.

Owing to the combustion air (11) fed in and thus an increased exothermic oxidation reaction, the synthesis gas produced has a relatively low calorific value and hydrogen content. Since the electric plasma power for providing the reaction heat can be reduced at the same time, the efficiency in the case of a power generation plant having a gas engine, fuel cell or gas turbine is increased.

In process engineering, the term allothermal refers to conversion processes in which supply of heat from outside is necessary (endothermic reaction); however, the introduction of heat itself does not bring about any direct chemical change (e.g. by means of combustion). Examples are allothermal pyrolyses in which the biomass is cracked by means of heat introduced from the outside.

The invention also relates to a process for gasifying solid or liquid gasification materials, in particular biomass, at pressures in the range from atmospheric pressure to 10 MPa and at temperatures in the range from 800° C. to 1500° C. to form a highly calorific synthesis gas, wherein an endothermic steam gasification process proceeds in the gasification space of an entrained flow gasifier and a plasma introduces reaction heat into the gasification space in such a quantity that the temperature is kept below the ash softening temperature.

### LIST OF REFERENCE NUMERALS

1. Gasification reactor
2. Plasma generator
3. Quenching space for full quenching
4. Venturi scrubber
5. Hydrogen plant/chemical synthesis plant
6. Synthesis gas blower
7. Plasma lance with means for introduction of energy
8. Quenching space for partial quenching
9. Utilization of waste heat for steam generation
10. Dust filter
11. Introduction of air
12. Utilization of waste heat for preheating air
13. Sooty water plant
14. Introduction of plasma gas
15. Gas engine/gas turbine
16. Gasification material, biomass
17. Introduction of electric energy
18. Filter cake
19. Particles
20. Steam export

1. A process for gasifying solid or liquid gasification materials at pressures in the range from atmospheric pressure to 10 MPa and at gasification temperatures in the range from 800° C. to 1500° C. to form a synthesis gas, comprising:
performing an endothermic steam gasification process according to an entrained flow principle using a plasma of intermediate temperature, <3500° C.; and
introducing required heat of reaction at least partly by means of the plasma.

2. The process as claimed in claim 1, further comprising all of the introducing of the required heat of reaction is by means of the plasma.

3. The process as claimed in claim 1, further comprising generating the plasma of intermediate temperature by means of a DC discharge.

4. The process as claimed in claim 1, further comprising generating the plasma of intermediate temperature by means of a low-frequency AC discharge.

5. The process as claimed in claim 1, further comprising generating the plasma of intermediate temperature by means of electromagnetic waves.

6. The process as claimed in claim 1, further comprising:
arranging one or more plasma lances connected to a plasma generator in a gasification space of the entrained flow gasifier for generating the plasma of intermediate temperature and cooling one or more plasma lances.

7. The process as claimed in claim 6, further comprising cooling the one or more plasma lances by steam.

8. The process as claimed in claim 6, further comprising cooling the one or more plasma lances by recirculated synthesis gas.

9. The process as claimed in claim 6, further comprising feeding an oxidant, air or oxygen to the gasification reactor via a plasma lance.

10. The process as claimed in claim 6, further comprising feeding an oxidant, air or oxygen to the gasification reactor separately from a plasma lance.

11. The process as claimed in claim 6, further comprising regulating the gasification temperature by a plasma gas flow selected for keeping the gasification temperature below an ash softening temperature.

12. The process as claimed in claim 6, further comprising cooling the synthesis gas produced by a combination of water quenching and waste heat utilization and using the steam produced for cooling the plasma lances and for the steam gasification reaction and exporting excess steam.

13. The process as claimed in claim 6, further comprising cooling the synthesis gas produced by waste heat utilization and using the steam produced for cooling the plasma lances and for the steam gasification reaction and exporting excess steam.

14. The process as claimed in claim 6, further comprising cooling the synthesis gas produced by a two-stage utilization of waste heat comprising:
in a first stage, preheating the air (oxygen-containing gas) used for the gasification process;
in a second stage generating steam for cooling the plasma lances and for the steam gasification reaction is generated, and
exporting excess steam.

15. The process as claimed in claim 1, further comprising cooling the synthesis gas produced by a combination of water quenching and utilization of waste heat for preheating an oxygen-containing gas/air, and using the gas/air as oxidant for the gasification process.

16. The process as claimed in claim 1, further comprising cooling the synthesis gas produced by water quenching.

17. The process as claimed in claim 1, further comprising purifying the cooled synthesis gas by dry gas purification; and
removing solid particles.

18. The process as claimed in claim 1, further comprising purifying the cooled synthesis gas by performing a wet scrub.

19. The process as claimed in claim 1, further comprising introducing biomass having a particle size of <2 mm by a mechanical feed system into the entrained flow gasification reactor.

20. An entrained flow gasifier configured for performing a process as claimed in claim 1, for gasifying liquid fuels and solid fuels, wherein the gasifier is configured to use steam as an oxidant at temperatures in the range from 800 to 1500° C. and pressures in the range from ambient pressure to 10 MPa to form synthesis gas;
the gasifier comprising a plasma generator for a nonthermal plasma of intermediate temperature <3500° C., arranged in a gasification space of the entrained flow gasifier.

21. The entrained flow gasifier as claimed in claim 20, further comprising plasma lances connected to the plasma generator and arranged as means for introduction of energy.

22. The entrained flow gasifier of claim 21, further comprising the gasifier is configured for gasifying a fuel in a form of biomass.

23. The process as claimed in claim 1, further comprising:
the introducing of the required heat of reaction is in such a quantity that the gasification temperature is kept below an ash softening temperature.

24. The process as claimed in claim 1, wherein the intermediate temperature, <2000° C.

25. The entrained flow gasifier of claim 20, wherein the intermediate temperature, <2000° C.
